(19) United States
(12) Patent Application Publication
(10) Pub. No.: US 2024/0302215 A1
(43) Pub. Date: Sep. 12, 2024

(54) CONTROL METHOD AND COLOR MEASUREMENT APPARATUS

(71) Applicant: SEIKO EPSON CORPORATION, Tokyo (JP)

(72) Inventors: Masayoshi MIYAKAWA, SUWA-SHI (JP); Masahide MORIYAMA, MATSUMOTO-SHI (JP); Toru HAYASHI, SUWA-SHI (JP)

(21) Appl. No.: 18/595,942

(22) Filed: Mar. 5, 2024

(30) Foreign Application Priority Data
Mar. 8, 2023 (JP) 2023-035700

(51) Int. Cl. G01J 3/52

(52) U.S. Cl. CPC G01J 3/52

(57) ABSTRACT

A control method of a color measurement apparatus including a support base, a colorimeter, a carriage that supports the colorimeter, and a scanning mechanism portion that causes the carriage to perform scanning on the support base, includes a color measurement step of performing color measurement by the color measurement portion, by moving the carriage from the color measurement target in a height direction and separating the color measurement portion from the color measurement target from a state in which the color measurement portion is in contact with the color measurement target, at a plurality of positions having different gaps between the carriage and the color measurement target in the height direction, and a calculation step of calculating an adjustment value for determining a setting position of the carriage in the height direction based on a color measurement result in the color measurement step.

The present application is based on, and claims priority from JP Application Serial Number 2023-035700, filed Mar. 8, 2023, the disclosure of which is hereby incorporated by reference herein in its entirety.

### BACKGROUND

### 1. Technical Field

The present disclosure relates to a control method and a color measurement apparatus.

### 2. Related Art

In the related art, various color measurement apparatuses that measure a color of a color measurement target are used. For example, JP-A-2016-212001 discloses an automatic color measurement apparatus to which a colorimeter that measures a color of a measurement target is attached. The automatic color measurement apparatus of JP-A-2016-212001 is a color measurement apparatus in which a colorimeter that is a color measurement portion performs color measurement in a non-contact state with respect to a measured object that is a color measurement target.

In the color measurement apparatus such as the automatic color measurement apparatus of JP-A-2016-212001, in which the color measurement portion performs color measurement in a non-contact state with respect to the color measurement target, there is a concern that extraneous light enters the gap between the color measurement portion and the color measurement target and the color measurement accuracy deteriorates. Therefore, it is conceivable to use a colorimeter having a color measurement portion that measures a color of the color measurement target in a state of being in contact with the color measurement target. However, even in the color measurement apparatus having such a configuration, the color measurement accuracy may deteriorate, due to variation in manufacturing tolerances or the like of the colorimeter, when a height of the colorimeter with respect to the color measurement target deviates from a desired height such as when the colorimeter floats with respect to the color measurement target. In addition, for example, in a color measurement apparatus configured to perform color measurement with respect to a plurality of patches provided on the color measurement target, there is a concern that the color measurement time increases when a separation distance between the color measurement target and the color measurement portion is increased when the colorimeter moves between the plurality of patches to suppress contact between the color measurement target and the color measurement portion. JP-A-2016-212001 does not describe a specific structure related to a height direction adjustment of a colorimeter.

### SUMMARY

According to an aspect of the present disclosure, there is provided a control method of a color measurement apparatus including a support base that supports a color measurement target, a colorimeter that has a color measurement portion that measures a color of the color measurement target in a state of being in contact with the color measurement target, a carriage that supports the colorimeter, and a scanning mechanism portion that causes the carriage to perform scanning on the support base, the control method including a color measurement step of performing color measurement by the color measurement portion, by moving the carriage from the color measurement target in a height direction, at a plurality of positions having different gaps between the carriage and the color measurement target in the height direction, and a calculation step of calculating an adjustment value for determining a setting position of the carriage in the height direction based on a color measurement result in the color measurement step.

According to another aspect of the present disclosure, there is provided a color measurement apparatus including a support base that supports a color measurement target, a colorimeter that includes a color measurement portion that measures a color of the color measurement target in a state of being in contact with the color measurement target, a carriage that supports the colorimeter, a scanning mechanism portion that causes the carriage to perform scanning on the support base, and a control portion that controls the colorimeter, the carriage, and the scanning mechanism portion, in which the control portion performs color measurement by the color measurement portion at a plurality of positions having different gaps between the carriage and the color measurement target in a height direction by moving the carriage from the color measurement target in the height direction, and calculates an adjustment value for determining a setting position of the carriage in the height direction, based on a color measurement result of the color measurement portion.

### BRIEF DESCRIPTION OF THE DRAWINGS

FIG. 1 is a schematic perspective view of a colorimeter that can be used in a color measurement apparatus according to an example of the present disclosure.

FIG. 2 is a perspective view of the color measurement apparatus according to the example of the present disclosure.

FIG. 3 is a perspective view illustrating an internal configuration of the color measurement apparatus according to the example of the present disclosure.

FIG. 4 is a bottom view illustrating a periphery of a carriage of the color measurement apparatus according to the example of the present disclosure, and is a view illustrating a state in which the colorimeter of FIG. 1 is accommodated.

FIG. 5 is a rear view illustrating a periphery of the carriage of the color measurement apparatus according to the example of the present disclosure, and is a view illustrating a disposition when the colorimeter of FIG. 1 is accommodated and the carriage is caused to perform scanning.

FIG. 6 is a rear view illustrating a periphery of the carriage of the color measurement apparatus according to the example of the present disclosure, and is a view illustrating a disposition at a moment at which the colorimeter of FIG. 1 is accommodated, the carriage is moved downward from the state of FIG. 5, and a color measurement portion comes into contact with a color measurement target.

FIG. 7 is a rear view illustrating a periphery of the carriage of the color measurement apparatus according to the example of the present disclosure, and is a view illustrating a disposition when the colorimeter of FIG. 1 is accommodated, the carriage is further moved downward from the state of FIG. 6, and a color of the color measurement target is measured.

FIG. 8 is a rear view illustrating a periphery of the carriage of the color measurement apparatus according to the example of the present disclosure, and is a view illustrating a disposition when the colorimeter of FIG. 1 is accommodated, the carriage is further moved downward from the state of FIG. 7, and a bottom surface of the carriage comes into contact with the color measurement target.

FIG. 9 is a rear view illustrating a periphery of the carriage of the color measurement apparatus according to the example of the present disclosure, and is a view illustrating a disposition in a state in which the colorimeter of FIG. 1 is accommodated and the carriage is moved to a home position.

FIG. 10 is an example of a control method performed using the color measurement apparatus according to the example of the present disclosure, and is a flowchart illustrating a flow of determining a setting position of the carriage in a height direction.

FIG. 11 is a graph representing a color difference of a color measurement value when a carriage is raised, with respect to a color measurement value obtained by measuring a color in a state in which the carriage is in contact with the color measurement target.

FIG. 12 is an example of a control method performed using the color measurement apparatus according to the example of the present disclosure, and is a flowchart illustrating a flow of measuring a thickness of the color measurement target in the height direction, which is performed before execution of the flow of the flowchart of FIG. 10.

FIG. 13 is an example of a control method performed using the color measurement apparatus according to the example of the present disclosure, and is a flowchart illustrating a flow when the colorimeter to be used is changed.

### DESCRIPTION OF EMBODIMENTS

Hereinafter, the present disclosure will be schematically described.

A control method according to a first aspect is a control method of a color measurement apparatus including a support base that supports a color measurement target, a colorimeter that has a color measurement portion that measures a color of the color measurement target in a state of being in contact with the color measurement target, a carriage that supports the colorimeter, and a scanning mechanism portion that causes the carriage to perform scanning on the support base, the control method including a color measurement step of performing color measurement by the color measurement portion, by moving the carriage from the color measurement target in a height direction, at a plurality of positions having different gaps between the carriage and the color measurement target in the height direction, and a calculation step of calculating an adjustment value for determining a setting position of the carriage in the height direction based on a color measurement result in the color measurement step.

According to the present aspect, color measurement is performed by the color measurement portion, by moving the carriage from the color measurement target in a height direction, at a plurality of positions having different gaps between the carriage and the color measurement target in the height direction, and an adjustment value is calculated for determining a setting position of the carriage in the height direction based on a color measurement result in the color measurement step. That is, for each colorimeter to be used, for example, a preferable setting position of the carriage, for example, the position of the carriage in the height direction when color measurement is performed on the color measurement target or the position of the carriage in the height direction when the colorimeter is moved between a plurality of patches, or the like, can be determined. Therefore, the height of the colorimeter with respect to the color measurement target can be suppressed from deviating from a desired height.

Next, the control method according to a second aspect is an aspect involved in the first aspect, in which in the calculation step, a height of the carriage from the color measurement target, when a color measurement value that is color-measured by the colorimeter in the color measurement step exceeds a predetermined threshold value, is obtained as a comparative value, and the adjustment value is calculated based on a difference between the comparative value and a reference value.

According to the present aspect, a height of the carriage from the color measurement target, when a color measurement value that is color-measured by the colorimeter in the color measurement step exceeds a predetermined threshold value, is obtained as a comparative value, and the adjustment value is calculated based on a difference between the comparative value and a reference value. When the setting position is determined from the height of the carriage when the comparative value becomes the reference value itself, although a concern occurs that the colorimeter floats up from the color measurement target due to a manufacturing tolerance or the like of the color measurement target, the colorimeter, or the like, the concern can be reduced by determining the setting position based on a value obtained by correcting the comparative value. That is, the height of the colorimeter with respect to the color measurement target can be effectively suppressed from deviating from a desired height.

Next, the control method according to a third aspect is an aspect involved in the first or second aspect, in which the color measurement step is performed in a state in which the color measurement portion is positioned at a center position of the color measurement target when viewed from the height direction.

According to the present aspect, the color measurement step is performed in a state in which the color measurement portion is positioned at a center position of the color measurement target when viewed from the height direction. Since the center position of the color measurement target is often the average planeness of the color measurement target, the height of the colorimeter with respect to the color measurement target can be effectively suppressed from deviating from a desired height by using such a control method.

Next, the control method according to a fourth aspect is an aspect involved in any one of the first to third aspects, in which the color measurement step is performed a plurality of times at a predetermined position of the color measurement target, and in the calculation step, the adjustment value is calculated based on an average value of color measurement results in the color measurement step performed a plurality of times.

According to the present aspect, the color measurement step is performed a plurality of times at a predetermined position of the color measurement target, and in the calculation step, the adjustment value is calculated based on an average value of color measurement results in the color measurement step performed a plurality of times. By performing the color measurement step a plurality of times, the accurate adjustment value can be calculated, and the height of the colorimeter with respect to the color measurement target can be effectively suppressed from deviating from a desired height.

Next, the control method according to a fifth aspect is an aspect involved in any one of the first to fourth aspects, in which the color measurement step is performed at at least two or more positions of the color measurement target, and in the calculation step, the adjustment value is calculated based on an average value of color measurement results in the color measurement step performed at two or more positions.

According to the present aspect, the color measurement step is performed at at least two or more positions of the color measurement target, and in the calculation step, the adjustment value is calculated based on an average value of color measurement results in the color measurement step performed at two or more positions. Although the planeness of the color measurement target may be non-uniform, the height of the colorimeter with respect to the color measurement target can be effectively suppressed from deviating from a desired height by using such a control method.

Next, the control method according to a sixth aspect is an aspect involved in any one of the first to fifth aspects, further including with the color measurement apparatus configured to use a plurality of types of the colorimeters, all of which have identification information, and including a storage portion configured to store the identification information, an acquisition step of acquiring first identification information in the identification information of a first colorimeter supported by the carriage among the colorimeters; and a determination step of determining whether or not the first identification information matches the identification information stored in the storage portion, in which when it is determined in the determination step that the first identification information does not match the identification information stored in the storage portion, a storage step of storing the first identification information acquired in the acquisition step in the storage portion is performed, and the calculation step is performed.

According to the present aspect, when it is determined in the determination step that the first identification information does not match the identification information stored in the storage portion, a storage step of storing the first identification information acquired in the acquisition step in the storage portion is performed, and the calculation step is performed. By using such a control method, since it can be determined whether or not the calculation step is performed for each colorimeter to be newly used, although the colorimeter that is not previously used is attached, the height of the colorimeter with respect to the color measurement target can be suppressed from deviating from a desired height.

Next, the control method according to a seventh aspect is an aspect involved in the sixth aspect, in which when it is determined in the determination step that the first identification information matches the identification information stored in the storage portion, the storage step and the calculation step are not performed.

According to the present aspect, when it is determined in the determination step that the first identification information matches the identification information stored in the storage portion, the storage step and the calculation step are not performed. By using such a control method, when the colorimeter that is previously used is attached, the flow of determining the setting position of the carriage can be omitted. Accordingly, the time required for the flow of determining the setting position of the carriage can be shortened.

Next, the control method according to an eighth aspect is an aspect involved in any one of the first to seventh aspects, in which the setting position of the carriage is a position of the carriage in the height direction when color measurement is performed on the color measurement target.

According to the present aspect, the setting position of the carriage is a position of the carriage in the height direction when color measurement is performed on the color measurement target. Therefore, the position of the carriage in the height direction when color measurement is performed on the color measurement target can be effectively suppressed from deviating from a desired height.

Next, the control method according to a ninth aspect is an aspect involved in any one of the first to seventh aspects, in which the color measurement apparatus is configured to perform color measurement by the colorimeter by repeatedly causing the carriage to perform scanning with respect to a plurality of patches provided on the color measurement target, and the setting position of the carriage is a position of the carriage in the height direction when the colorimeter is moved in scanning of the carriage from a first color measurement position to a second color measurement position corresponding to positions of the plurality of patches.

According to the present aspect, the setting position of the carriage is a position of the carriage in the height direction when the colorimeter is moved in scanning of the carriage from a first color measurement position to a second color measurement position corresponding to positions of the plurality of patches. Therefore, the position of the carriage in the height direction when the colorimeter is moved between the plurality of patches can be effectively suppressed from deviating from a desired height.

Next, the color measurement apparatus according to a tenth aspect is a color measurement apparatus including a support base that supports a color measurement target, a colorimeter that includes a color measurement portion that measures a color of the color measurement target in a state of being in contact with the color measurement target, a carriage that supports the colorimeter, a scanning mechanism portion that causes the carriage to perform scanning on the support base, and a control portion that controls the colorimeter, the carriage, and the scanning mechanism portion, in which the control portion performs color measurement by the color measurement portion at a plurality of positions having different gaps between the carriage and the color measurement target in a height direction by moving the carriage from the color measurement target in the height direction, and calculates an adjustment value for determining a setting position of the carriage in the height direction, based on a color measurement result of the color measurement portion.

According to the present aspect, color measurement is performed by the color measurement portion, by moving the carriage from the color measurement target in a height direction, at a plurality of positions having different gaps between the carriage and the color measurement target in the height direction, and an adjustment value is calculated for determining a setting position of the carriage in the height direction based on a color measurement result in the color measurement step. That is, for each colorimeter to be used, for example, a preferable setting position of the carriage, for example, the position of the carriage in the height direction when color measurement is performed on the color measurement target or the position of the carriage in the height direction when the colorimeter is moved between a plurality of patches, or the like, can be determined. Therefore, the height of the colorimeter with respect to the color measurement target can be suppressed from deviating from a desired height.

Hereinafter, the present disclosure will be specifically described.

An X-Y-Z coordinate system illustrated in each drawing is an orthogonal coordinate system, an X-Y plane is a horizontal plane, and an X-Z plane and a Y-Z plane are vertical planes. Here, the Z-axis direction is a vertical direction, that is, a height direction, and a +Z direction is a vertically upward direction and a −Z direction is a vertically downward direction. In addition, the X-axis direction is a horizontal direction orthogonal to the Z-axis direction that is a vertical direction. In addition, the Y-axis direction is a horizontal direction and is a direction orthogonal to both the X-axis direction and the Z-axis direction. In the following description, the +Y direction side of a color measurement apparatus 1 is referred to as the rear direction side, the −Y direction side of the color measurement apparatus 1 is referred to as the front direction side, the +X direction side of the color measurement apparatus 1 is referred to as the right direction side, and the −X direction side of the color measurement apparatus 1 is referred to as the left direction side.

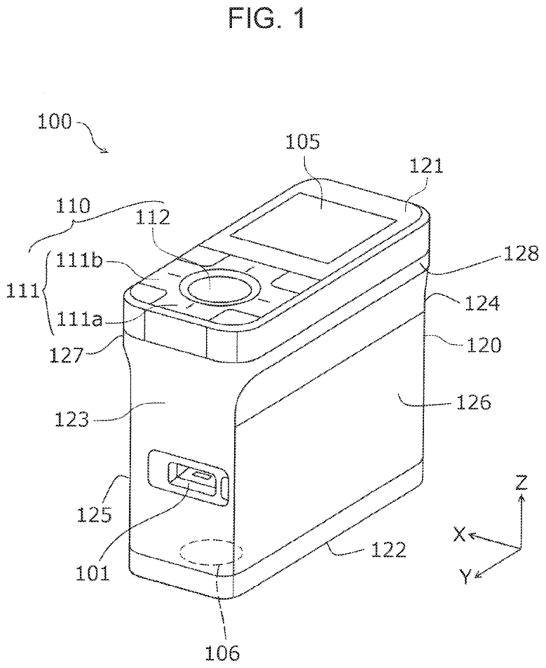

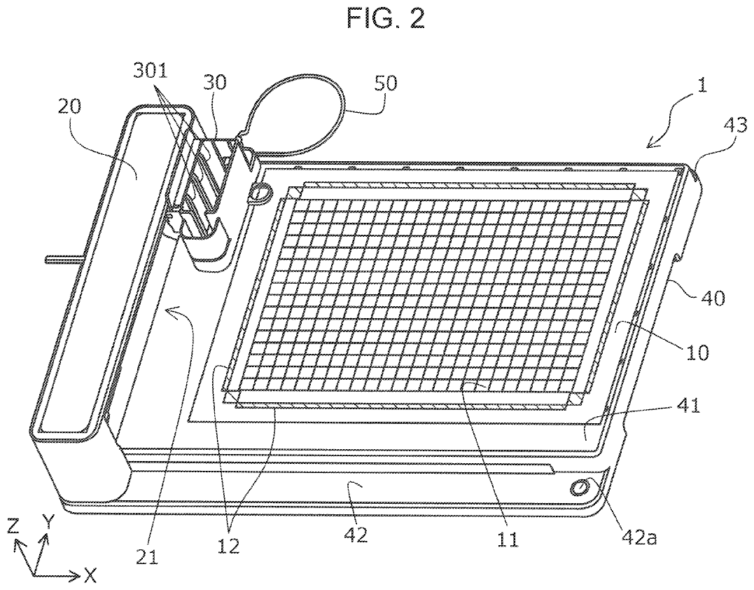

First, with reference to FIG. 1, an example of a colorimeter 100 that can be used in the color measurement apparatus 1 according to an example of the present disclosure will be described. The colorimeter 100 according to the present example includes a color measurement port 106, and is an optical device that emits light in the −Z direction from the color measurement port 106 and performs color measurement by receiving light reflected by a color chart 10, which is a color measurement target, as illustrated in FIG. 2. In other words, the optical axis direction is the Z-axis direction, and the position of the optical axis corresponds to the position of the color measurement port 106.

The colorimeter 100 according to the present example includes a casing 120 having an upper surface 121 that is a surface on the +Z direction side, a color measurement surface 122 that is a bottom surface on the −Z direction side and is provided with the color measurement port 106, a rear surface 123 that is a surface on the +Y direction side, a front surface 124 that is a surface on the −Y direction side, a right surface 125 that is a surface on the +X direction side, and a left surface 126 that is a surface on the −X direction side.

An operation portion 110 and a screen portion 105 are disposed on the upper surface 121 in the Y-axis direction. Specifically, the operation portion 110 is provided on the +Y direction side of the upper surface 121, and the screen portion 105 is provided on the −Y direction side of the upper surface 121. The operation portion 110 includes a plus-shaped button 111 configured with a bar shape 111a extending in the Y-axis direction and a bar shape 111b extending in the X-axis direction, and a determination button 112 provided at the center of the plus-shaped button 111. For example, a user moves the menus to be activated in front/rear and left/right directions by pressing the plus-shaped button 111 with respect to a plurality of menus displayed on the screen portion 105, and can determine the desired menu by pressing the determination button 112.

A terminal 101 to which a USB cable 50 illustrated in FIG. 1 or the like can be coupled is provided on the rear surface 123. In addition, the colorimeter 100 of the present example is provided with a projection portion 127 and a projection portion 128 that are projected toward the outside when viewed in the Y-axis direction. Specifically, the projection portion 127 is provided in an area on the +Z direction side as compared with the center portion of the right surface 125 in the Z-axis direction, and the projection portion 128 is provided in an area on the +Z direction side as compared with the center portion of the left surface 126 in the Z-axis direction.

Next, a detailed configuration of the color measurement apparatus 1 according to the example of the present disclosure will be described with reference to FIGS. 2 to 9. FIG. 2 illustrates a configuration of the color measurement apparatus 1 of the present example. The color measurement apparatus 1 includes a main body portion 40 having a support base 41 extending in the X-axis direction and the Y-axis direction, and further includes a gantry 20 extending in the Y-axis direction to cover a portion of the support base 41 from the +Z direction side.

A carriage 30 that can accommodate the colorimeter 100 is attached to the gantry 20. The gantry 20 can move in the X-axis direction with respect to the support base 41, and the carriage 30 can move in the Y-axis direction with respect to the gantry 20. These movements are also referred to as scanning. Here, the carriage 30 can move in the Y-axis direction with respect to the gantry 20, and can also move in the Z-axis direction with respect to the gantry 20. One end of the USB cable 50 is coupled to the gantry 20 and the other end of the USB cable 50 is coupled to the colorimeter 100 accommodated in the carriage 30.

The color chart 10, which is an example of a measurement target, can be placed on the support base 41, and the color chart 10 is composed by, for example, a plurality of color patches 11, a black frame 12, or the like. The color chart 10 is fixed to the support base 41 by, for example, attaching an adhesive tape at a periphery of the color chart 10, and corresponds to automatic color measurement up to A3 size, for example. However, since the gantry 20 has a gate shape when viewed from the X-axis direction and has a space portion 21 corresponding to the gate shape, a long paper that exceeds the A3 size can be also placed in the X-axis direction on the support base 41.

On the −Y direction side of the main body portion 40, a front surface 42 is provided at a position lower in the −Z direction side than the support base 41, and on the +Y direction side of the main body portion 40, a rear surface 43 is provided at a position lower in the −Z direction side than the support base 41. A power button 42a that is an example of an operation portion of the color measurement apparatus 1 is provided on the front surface 42.

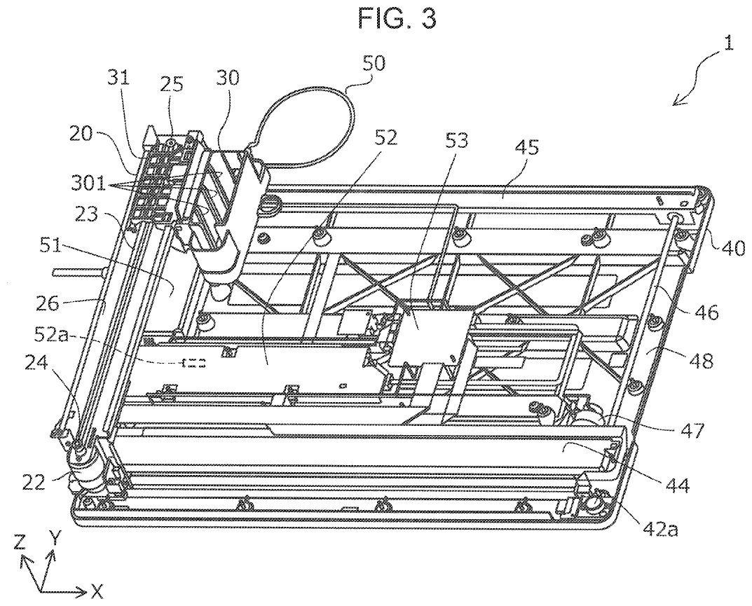

FIG. 3 illustrates an internal configuration of the color measurement apparatus 1, and is a view in which the exterior component of FIG. 2 is removed. On the +Z direction side above a case lower 48, the front frame 44 and the rear frame 45 are disposed to extend in the X-axis direction at an interval, and a gantry frame 26 having a gate shape and composing a portion of the gantry 20 moves in the X-axis direction along the front frame 44 and the rear frame 45.

The front frame 44 and the rear frame 45 are coupled by a coupling shaft 46 at a position on the +X direction side of the main body portion 40, and the rotational drive of a gantry motor 47 is transmitted from the gantry motor 47, which is a power source for moving the gantry 20 in the X-axis direction, to the coupling shaft 46 via a gear group (not illustrated). By the rotational drive transmitted to the coupling shaft 46, an endless belt (not illustrated) hung on a pulley (not illustrated) provided on the side of the front frame 44 that is the −Y direction side of the coupling shaft 46, and an endless belt (not illustrated) hung on a pulley (not illustrated) provided on the side of the rear frame 45 that is the +Y direction side of the coupling shaft 46 are rotated, and the gantry frame 26 coupled to the endless belts is moved.

A carriage motor 22 is fixed to the front side corresponding to the −Y direction side of the gantry frame 26, and an endless carriage belt 23 hung on a front pulley 24 and a back pulley 25 rotates via the front pulley 24 coupled to the carriage motor 22. A carriage slider 31, which composes a portion of the carriage 30, is fixed to the carriage belt 23, and moves along the Y-axis direction in accordance with the pivoting operation of the carriage belt 23 accompanying the pivoting operation of the carriage motor 22. Inside the main body portion 40, a main substrate 52, a sub-substrate 53, a power supply box 51, or the like as a control portion are provided. The main substrate 52 as the control portion is provided with a non-volatile storage portion 52a that can store information.

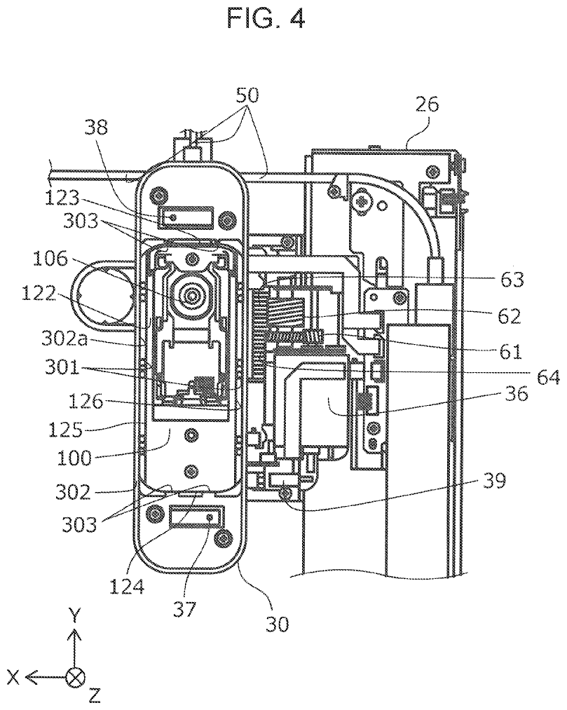

FIG. 4 is a bottom view illustrating a periphery of the carriage 30 in a state in which the colorimeter 100 is attached to the carriage 30. The colorimeter 100 is supported by the carriage 30, in which the right surface 125 and the left surface 126 are supported in the Y-axis direction by a rib 301 provided on the carriage 30, and the rear surface 123 and the front surface 124 are supported in the X-axis direction by a rib 303 provided on the carriage 30. As illustrated in FIG. 4, a front side sensor 37 and a rear side sensor 38 configured to measure a width of the measurement target are provided on a surface of the carriage 30 on the −Z direction side.

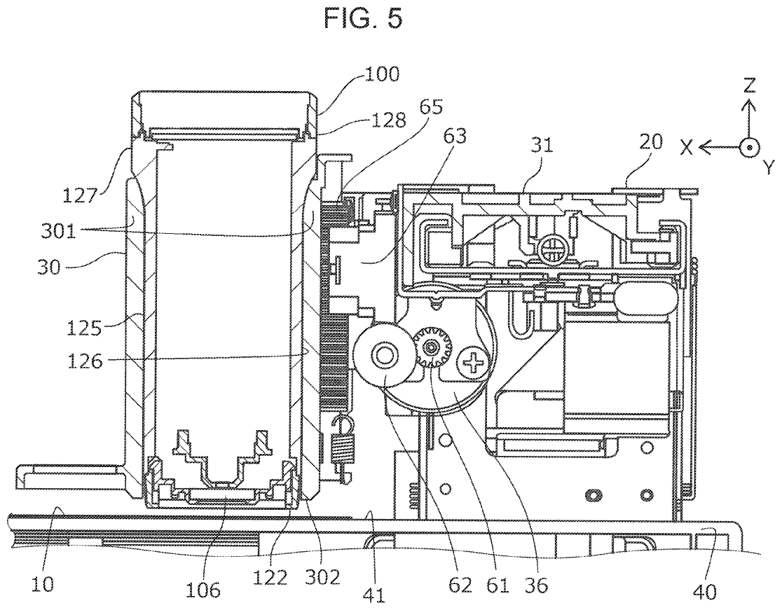

In the carriage 30, the power of the Z-axis movement direction movement motor 36, which is a drive source, is transmitted to the motor gear 61, the worm gear 62, the first driving gear 63, and the second driving gear 64 in this order, so that the carriage 30 slidably moves in the Z-axis direction with respect to the gantry 20 via the rack gear 65 illustrated in FIG. 5 or the like. In addition, as illustrated in FIG. 4, the carriage 30 is provided with a home position sensor 39 that measures whether or not the position of the carriage 30 in the Z-axis direction with respect to the gantry 20 is a home position.

Next, mainly with reference to FIGS. 5 to 9, the position of the carriage 30 in the Z-axis direction with respect to the gantry 20, that is, the position of the carriage 30 and the colorimeter 100 accommodated in the carriage 30 in the Z-axis direction with respect to the measurement target placed on the support base 41 will be described. FIG. 5 is a view illustrating a disposition when the carriage 30 performs scanning in a state in which the colorimeter 100 is accommodated in the carriage 30, that is, when the carriage 30 is moved along the Y-axis direction with respect to the gantry 20. At this time, both the color measurement surface 122 of the colorimeter 100 and a bottom surface 302 of the carriage 30 are in a state in which a gap is vacant in the Z-axis direction with respect to the color chart 10 that is a measurement target.

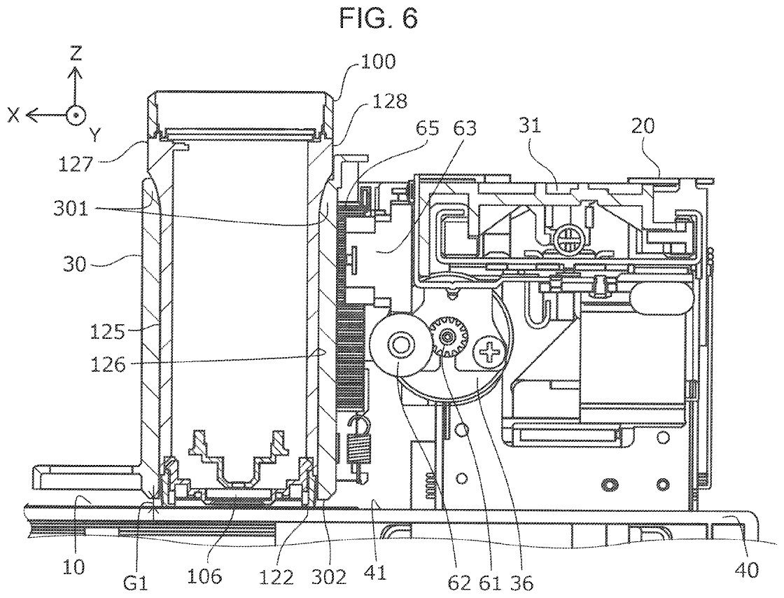

FIG. 6 is a view illustrating a disposition at the moment at which the carriage is moved downward in the −Z direction from the state of FIG. 5 and the color measurement surface 122 of the colorimeter 100 comes into contact with the color chart 10. For example, in the present example, a gap G1 in the Z-axis direction between the bottom surface 302 of the carriage 30 and the color chart 10 at this time is 2 mm. Here, in the present example, the colorimeter 100 is accommodated in the carriage 30 in a state in which the projection portion 127 and the projection portion 128 are caught and placed by their own weight on the rib 301 provided in the carriage 30, and the color measurement surface 122 of the colorimeter 100 is configured to protrude in the −Z direction from a hole portion 302a provided in the bottom surface 302 of the carriage 30 illustrated in FIG. 4.

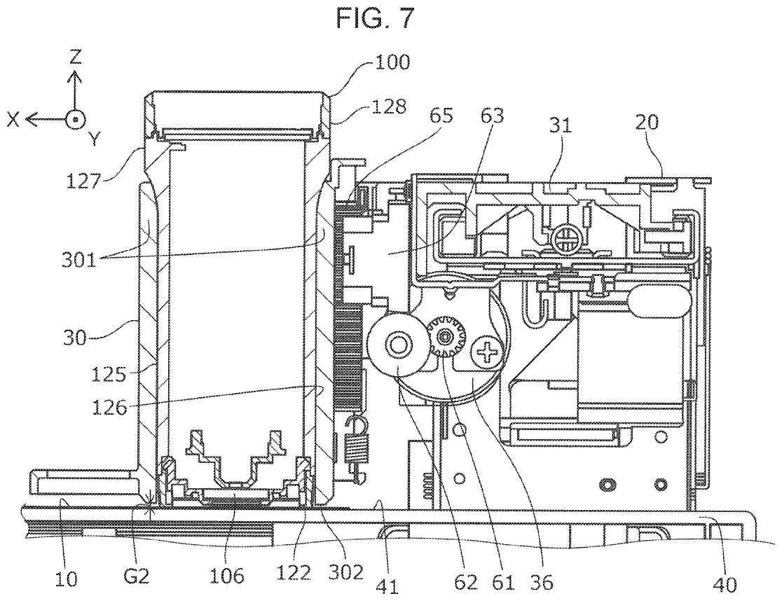

Therefore, as illustrated in FIG. 7, when the carriage 30 is further moved in the −Z direction from the state of FIG. 6, its own weight of the colorimeter 100 is applied to the color measurement surface 122. FIG. 7 illustrates a disposition when the color of the color measurement target is measured, that is, the disposition when the color of the color patch 11 and the black frame 12 of the color chart 10 is measured. For example, in the present example, the gap G2 in the Z-axis direction between the bottom surface 302 of the carriage 30 and the color chart 10 at this time is 1 mm. In other words, in the color measurement apparatus 1 of the present example, when the color of the color measurement target is measured, the color measurement surface 122 is in contact with the color measurement target, but the bottom surface 302 of the carriage 30 is in a state in which a gap is provided.

In the color measurement apparatus 1 of the present example, the color measurement is performed in a state in which the entire periphery of the color measurement surface 122 of the colorimeter 100 viewed from the Z-axis direction comes into contact with the color chart 10 on the support base 41 and follows the surface of the color chart 10. With such a configuration, color measurement can be performed in a state in which the color measurement port 106 that is an optical axis opening of the colorimeter 100 is covered with the color measurement surface 122, so that it is unlikely affected by external light and color measurement accuracy rises. Even in the state of FIG. 6, color measurement can be performed in a state of being unlikely to be affected by external light, but since the carriage 30, the colorimeter 100, and the support base 41 have a tolerance due to manufacturing variations in parts or the like, the holding position of the colorimeter 100 of the carriage 30 or the distance from the color measurement surface 122 to the support base 41 may deviate. However, by further lowering the carriage 30 from the state of FIG. 6, color measurement can be performed without being affected by such a tolerance.

In addition, in a state of FIG. 7, the gap G2 is provided between the bottom surface 302 of the carriage 30 and the color chart 10, and the bottom surface 302 of the carriage 30 and the color chart 10 are in a state of being separated from each other. Therefore, the weight of the carriage 30 is not transmitted to the color chart 10, and it is in a state in which only its own weight of the colorimeter 100 is applied to the color chart 10. Therefore, the colorimeter 100 is in contact with the color chart 10 in a state in which an appropriate load is applied, so that the color chart 10 is unlikely to be damaged.

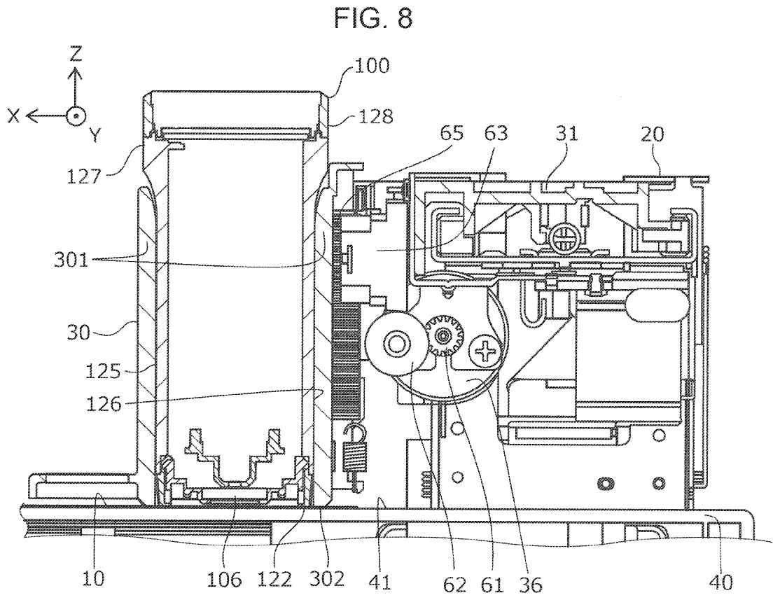

The color measurement apparatus 1 of the present example can measure color of various color measurement targets. The color measurement target that can be color-measured by the color measurement apparatus 1 of the present example has various thicknesses. Therefore, the color measurement apparatus 1 of the present example brings the carriage 30 into contact with the color measurement target by moving the carriage 30 in the Z-axis direction with respect to the color measurement target to be used, and the abutting height, which is the height of the carriage 30 at the contact time, can be measured. Describing from another viewpoint, the abutting height of the carriage 30 is a height of the carriage 30 when the color measurement target is abutted. Specifically, in the color measurement apparatus 1 of the present example, in order to know the abutting height of the carriage 30, by bringing the bottom surface 302 of the carriage 30 in contact with the color measurement target and driving the Z-axis movement direction movement motor 36 to continue lowering the height of the carriage 30 until a threshold value at which the load of the Z-axis movement direction movement motor 36 is present is exceeded, the height exceeding the threshold value is measured, so that the abutting height of the carriage 30 can be known. FIG. 8 is a view illustrating a state when, in order to know the abutting height of the carriage 30, the bottom surface 302 of the carriage 30 abuts the color chart 10 that is a color measurement target and the threshold value at which the load of the Z-axis movement direction movement motor 36 is present is exceeded.

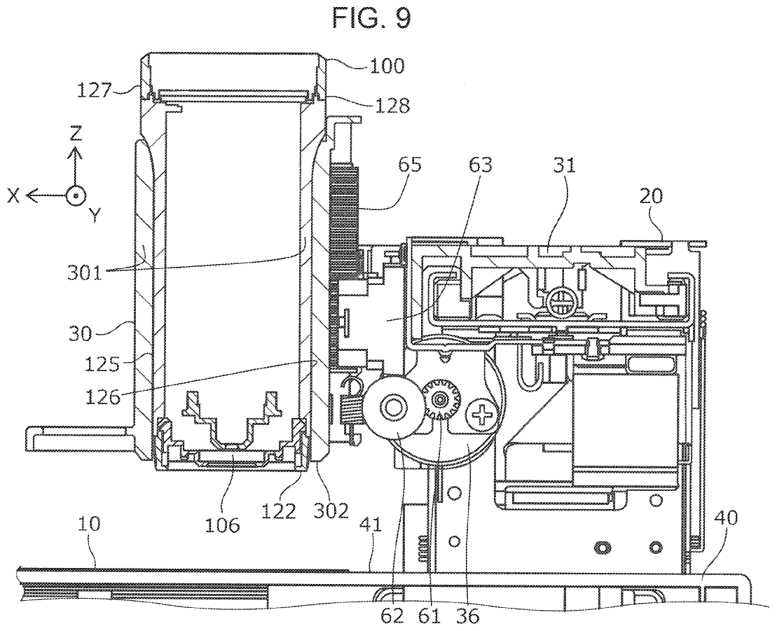

In addition, as described above, the color measurement apparatus 1 of the present example is provided with a home position sensor 39 that measures whether or not the position of the carriage 30 in the Z-axis direction with respect to the gantry 20 is a home position. FIG. 9 illustrates a state in which the carriage 30 is at the home position in the Z-axis direction.

As described above, the color measurement apparatus 1 of the present example includes the support base 41 supports the color chart 10 that is a color measurement target, the colorimeter 100 having the color measurement surface 122, which is a color measurement portion that measures the color of the color chart 10 in a state of being in contact with the color chart 10, and the carriage 30 that supports the colorimeter 100. In addition, the color measurement apparatus 1 of the present example includes the gantry 20, and the gantry 20 includes the carriage motor 22, the carriage belt 23, the front pulley 24, the back pulley 25, or the like, and serves as a scanning mechanism portion that causes the carriage 30 to perform scanning on the support base 41. In addition, the color measurement apparatus 1 of the present example includes the main substrate 52 as a control portion that controls the colorimeter 100, the carriage 30, and the scanning mechanism portion.

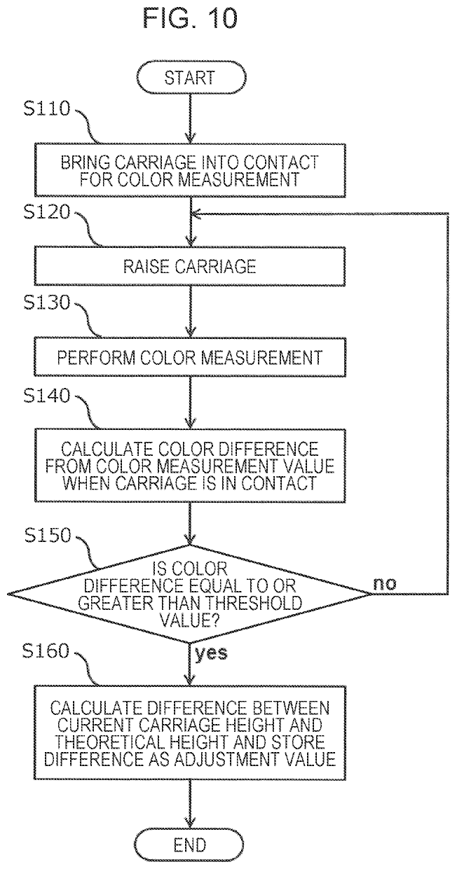

Hereinafter, a control method performed by using the color measurement apparatus 1 of the present example will be described. First, a flow when a setting position of the carriage in the height direction is determined, which is represented by the flowchart of FIG. 10, will be described. In the following control method, each step is executed by the control of the main substrate 52 as a control portion. When the present flow is started, first, in a step S110, the carriage 30 is brought into contact with a desired position on the color chart 10, and color measurement is performed in a state in which the carriage 30 is in contact with the color chart 10.

Next, in a step S120, the carriage is raised by a predetermined amount. In the present example, for example, the carriage is raised by 0.14 mm. Then, in a step S130, the color measurement is performed at a position at which the carriage is raised by the predetermined amount.

Then, in a step S140, the color difference between the color measurement value in the step S110, which is a state in which the carriage 30 is in contact with the color chart 10, and the color measurement value in the step S130 is calculated. As described above, in the color measurement apparatus 1 of the present example, it is necessary to raise the carriage 30 by approximately 2 mm when starting from the state in FIG. 8, which is the state in which the carriage 30 is brought into contact with the color chart 10, to reach the state in FIG. 6, which is the state in which the carriage 30 starts to be separated from the color chart 10. Therefore, until the carriage 30 is raised by approximately 2 mm, the color difference calculated in the step S140 is substantially zero. After raising the carriage 30 by 2 mm, when the color difference is calculated in a state in which the carriage 30 is further raised, the color difference increases as the carriage 30 is raised.

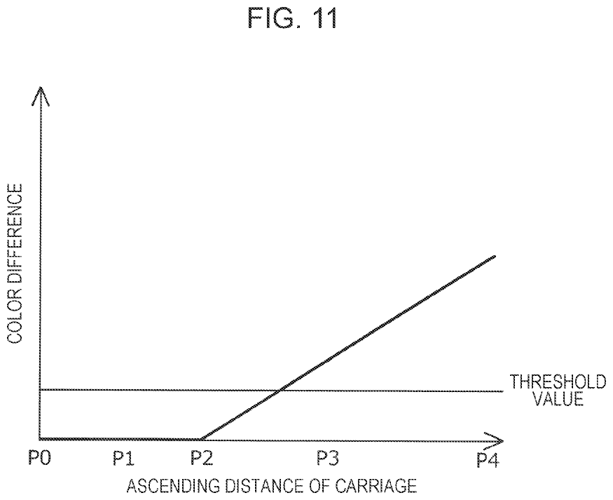

Here, FIG. 11 is a graph representing the color difference with respect to the ascending distance of the carriage 30 with respect to the color chart 10. As illustrated in FIG. 11, the color difference is substantially zero when the ascending distance of the carriage 30 with respect to the color chart 10 is less than or equal to a predetermined value, but thereafter the color difference increases as the carriage 30 is raised. In FIG. 11, a point P0 corresponds to a case where the carriage 30 is in the state of FIG. 8, a point P1 corresponds to a case where the carriage 30 is in the state of FIG. 7, a point P2 corresponds to a case where the carriage 30 is in the state of FIG. 6, a point P3 corresponds to a case where the carriage 30 is in the state of FIG. 5, and a point P4 corresponds to a case where the carriage 30 is in the state of FIG. 9.

Next, in a step S150, it is determined whether or not the color difference calculated in the step S140 is equal to or greater than a predetermined threshold value. This determination is made by the main substrate 52 as a control portion. Here, when it is determined that the color difference calculated in the step S140 is less than the threshold value, the process returns to the step S120, and the flows from the step S120 to the step S150 are repeated. That is, the color measurement is performed during raising the carriage 30 by 0.14 mm until the color difference calculated in the step S140 is equal to or greater than the threshold value. On the other hand, when it is determined that the color difference calculated in the step S140 is equal to or greater than the threshold value, the process proceeds to a step S160.

In the step S160, it is calculated how much difference there is for the current height of the carriage 30 with respect to the color chart 10, that is, the height of the carriage 30 with respect to the color chart 10 when it is determined that the color difference is equal to or greater than the threshold value in the step S150, in comparison with a theoretical height calculated in advance. Then, the calculation result is stored in the storage portion 52a, and the flow represented by the flowchart of FIG. 10 is ended.

The adjustment value calculated in the step S160 is used when determination is made on, for example, the setting position of the carriage 30 in the height direction when color measurement is performed on the color patch 11 or the like of the color chart 10 illustrated in FIG. 7, or the setting position of the carriage 30 in the height direction during scanning of the carriage 30 illustrated in FIG. 5. For example, when color measurement is continuously performed on the plurality of adjacent color patches 11 provided on the color chart 10, color measurement is performed with respect to the first color patch 11 at the setting position of the carriage 30 illustrated in FIG. 7, the carriage 30 is raised to the setting position of the carriage 30 represented by FIG. 5 and then moves to a color measurement position of the second color patch 11 adjacent to the first color patch 11, and color measurement is performed on the second color patch 11 after lowering the carriage 30 to the setting position of the carriage 30 represented by FIG. 7. Then, this is repeated for the number of color patches 11 on which color measurement is to be performed.

Here, the control method represented by the flowchart of FIG. 10 may be described in other words such that by moving the carriage 30 in the height direction from the color chart 10 by repeating the flows from the step S120 to the step S150, a color measurement step of performing color measurement using the color measurement surface 122 at a plurality of positions in which the gaps between the carriage 30 and the color chart 10 are different in the height direction, is executed. By executing the step S160, a calculation step of calculating an adjustment value for determining the setting position of the carriage 30 in the height direction is executed, based on the color measurement result in the color measurement step. In the control method represented by the flowchart of FIG. 10, the step S110 to the step S150, in which the step S110 is added to the step S120 to the step S150, correspond to the color measurement step, and the step S160 corresponds to the calculation step.

From the above description, by executing the control method represented by the flowchart of FIG. 10, for each colorimeter 100 used, a preferable setting position of the carriage 30, for example, the position of the carriage 30 in the height direction when color measurement is performed on the color chart 10 or the position of the carriage 30 in the height direction when the colorimeter 100 is moved between the plurality of color patches 11, or the like, can be calculated. Therefore, the height of the colorimeter 100 with respect to the color chart 10 can be suppressed from deviating from a desired height. It is conceivable to separately provide a sensor that measures the height of the colorimeter 100 as a unit for setting the height of the colorimeter 100 with respect to the color chart 10 to a desired height, but the necessity of providing such a sensor can be eliminated by executing the control method according to the present example.

In the control method represented by the flowchart of FIG. 10, the colorimeter 100 is gradually raised by 0.14 mm in the color measurement step to perform color measurement. However, the present disclosure is not limited to this method. For example, the color measurement may be periodically performed when the colorimeter 100 is continuously raised in the color measurement step, or the like.

Here, in the control method represented by the flowchart of FIG. 10, the adjustment value is calculated in the step S160 based on whether the color difference in the step S150 is equal to or greater than the threshold value. To describe this in other words, in the calculation step, the height of the carriage 30 from the color chart 10 when the color measurement value that is color-measured by the colorimeter 100 in the color measurement step exceeds the predetermined threshold value is used as a comparative value, and the adjustment value is calculated based on a difference between the comparative value and the theoretical height that is a reference value. Here, the comparative value corresponds to the color measurement value of the step S130, and the reference value corresponds to the color measurement value of the step S110. When the setting position of the carriage 30 is determined from the height of the carriage 30 when the comparative value becomes the reference value itself, although a concern occurs that the colorimeter 100 floats up from the color chart 10 due to a manufacturing tolerance or the like of the color chart 10, the colorimeter 100, or the like, the concern can be reduced by determining the setting position of the carriage 30 based on a value obtained by correcting the comparative value. That is, the height of the colorimeter 100 with respect to the color chart 10 can be effectively suppressed from deviating from a desired height. Specifically, in the present example, when the colorimeter 100 floats up from the color chart 10, the value that is lowered by 1 mm from the corresponding comparative value is used as the corrected value.

A position in the color chart 10 at which the color measurement step is executed is not particularly limited. However, in the present example, the color measurement step is performed in a state in which the color measurement port 106 of the color measurement surface 122 is positioned at the center position of the color chart 10 when viewed from the height direction. Since the center position of the color chart 10 is often the average planeness of the color chart 10, the height of the colorimeter 100 with respect to the color chart 10 can be effectively suppressed from deviating from a desired height by using such a control method. The “center position” here means that it is sufficient to be a substantially center position, and may correspond to, for example, the center area in each of the X-axis direction and the Y-axis direction when each of the X-axis direction and the Y-axis direction is divided into three equal portions.

In addition, the number of times of performing the color measurement step from the step S110 to the step S150 is not particularly limited. However, it is preferable that the color measurement step is performed a plurality of times at predetermined positions of the color chart 10, and the calculation step calculates the adjustment value based on an average value of the color measurement results in the color measurement steps performed a plurality of times. The is because, by performing the color measurement step a plurality of times, the accurate adjustment value can be calculated, and the height of the colorimeter 100 with respect to the color chart 10 can be effectively suppressed from deviating from a desired height.

In addition, it is preferable that the color measurement step is performed at at least two or more positions of the color chart 10, and the calculation step calculates the adjustment value based on the average value of the color measurement results in the color measurement step performed at two or more positions. This is because although the planeness of the color chart 10 may be non-uniform, the height of the colorimeter 100 with respect to the color chart 10 can be effectively suppressed from deviating from a desired height by using such a control method.

In the calculation step, the height of the carriage 30 from the color chart 10 when the color measurement value that is color-measured by the colorimeter 100 exceeds the predetermined threshold value may be obtained by an approximate method. For example, when the colorimeter 100 floats from the color chart 10, the color difference in the step S150 is substantially proportional to the height of the carriage 30 from the color chart 10. Therefore, by performing linear approximation between the color difference obtained after the color difference exceeds the predetermined threshold value and the height of the carriage 30, the height of the carriage 30 from the color chart 10 at which the color difference is the predetermined threshold value may be obtained.

In addition, the color measurement apparatus 1 of the present example determines the position of the carriage 30 in the height direction when color measurement is performed on the color patch 11 or the like of the color chart 10 as the setting position of the carriage 30, based on the adjustment value calculated in the step S160 that is the calculation step of the present example. Therefore, the position of the carriage 30 in the height direction when color measurement is performed on the color chart 10 can be effectively suppressed from deviating from a desired height.

Further, the color measurement apparatus 1 of the present example is configured to be able to repeatedly perform color measurement by the colorimeter 100 by repeating the scanning of the carriage 30 with respect to the plurality of color patch 11 provided on the color chart 10. Then, the color measurement apparatus 1 of the present example also determines the position of the carriage 30 in the height direction when the colorimeter 100 is moved, as the setting position of the carriage 30, in the scanning of the carriage 30 from a first color measurement position corresponding to the position of the first color patch among the plurality of color patches 11 to a second color measurement position corresponding to the position of the second color patch adjacent to the first color patch, based on the adjustment value calculated in the step S160 that is the calculation step of the present example. Specifically, a value obtained by correcting a value obtained by adding a value, by which the carriage 30 rises, for example, 2 mm, to the adjustment value calculated in the step S160 is calculated as the adjustment value during scanning, and is determined as the position of the carriage when the colorimeter is moved. Therefore, the position of the carriage 30 in the height direction when the colorimeter 100 is moved between the plurality of patches can be effectively suppressed from deviating from a desired height.

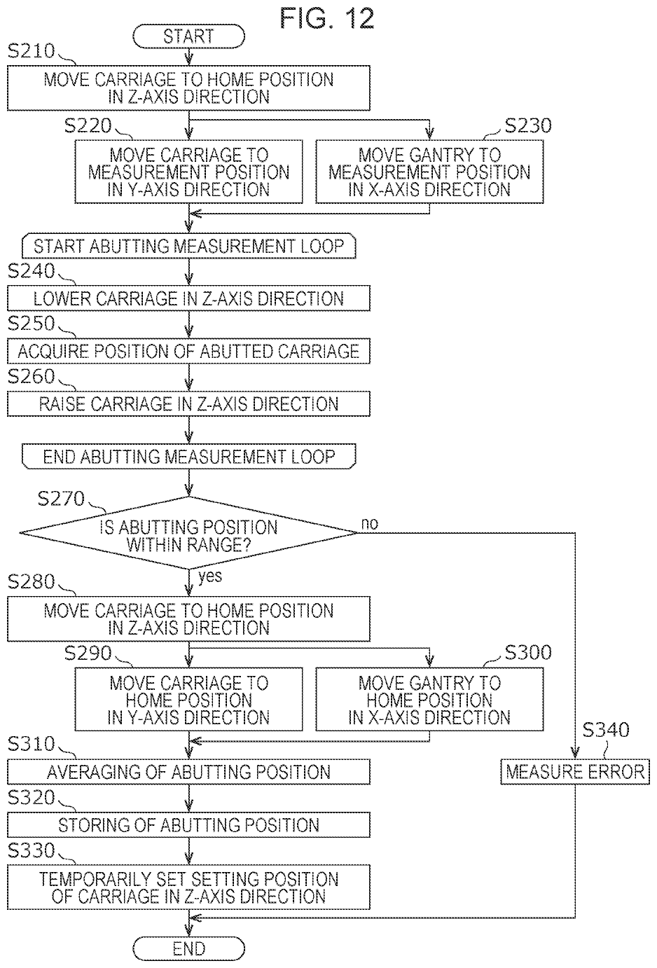

Next, a flow of measuring the thickness of the color measurement target in the height direction, which is performed before executing the flow of the flowchart of FIG. 10, which is represented by the flowchart of FIG. 12, will be described. When the flow of the flowchart of FIG. 12 is started, first, in a step S210, the Z-axis movement direction movement motor 36 is driven to move the carriage 30 to the home position illustrated in FIG. 9. Then, in a step S220, the carriage motor 22 is driven to move the carriage 30 in the Y-axis direction, and in a step S230, the gantry motor 47 is driven to move the gantry 20 in the X-axis direction and move the carriage 30 to a desired measurement position.

After that, an abutting measurement loop is performed in which the carriage 30 abuts the color chart 10 a plurality of times. In the abutting measurement loop, first, in a step S240, the carriage 30 is lowered along the Z-axis direction, which is the height direction. When the carriage 30 abuts the color chart 10, the position of the abutted carriage 30 in the Z-axis direction is acquired in a step S250. In the abutting measurement loop, the step S240 to a step S260 are repeated a plurality of times.

When the abutting measurement loop is ended, in a step S270, it is determined whether or not the positions of the abutted carriage 30 in the Z-axis direction obtained by repeating the plurality of times are within a predetermined range. Here, when the main substrate 52 determines that all the positions of the abutted carriage 30 in the Z-axis direction obtained by repeating a plurality of times are within the predetermined range, the process proceeds to a step S280. On the other hand, when the main substrate 52 does not determine that all the positions of the abutted carriage 30 in the Z-axis direction obtained by repeating a plurality of times are within the predetermined range, an error is measured in a step S340, and the flow of the flowchart of 12 is ended.

In the present example, such a process is performed in the step S270, but instead of such a process, for example, in the step S270, the result outside the predetermined range may be excluded to proceed to a step S280, or the result outside the predetermined range may be corrected to a predetermined upper limit value and a lower limit value to proceed to the step S280, or the like. In the step S280, the Z-axis movement direction movement motor 36 is driven to move the carriage 30 to the home position illustrated in FIG. 9. Then, in a step S290, the carriage motor 22 is driven to move the carriage 30 in the Y-axis direction, and in a step S300, the gantry motor 47 is driven to move the gantry 20 in the X-axis direction, move the carriage 30 to the home position in the Y-axis direction, and move the gantry 20 to the home position in the X-axis direction. FIGS. 2 and 3 illustrate a state in which the carriage 30 and the gantry 20 are at the home position.

Next, in a step S310, the plurality of abutting positions measured by the abutting measurement loop are averaged, and in a step S320, the averaged abutting position is stored in the storage portion 52a. Then, in a step S330, the setting position of the carriage 30 in the Z-axis direction is temporarily set with reference to the averaged abutting position, and the flow of the flowchart of FIG. 10 is ended. The setting position of the carriage 30 temporarily set is corrected by executing the flow of the flowchart of FIG. 9 and is permanently set.

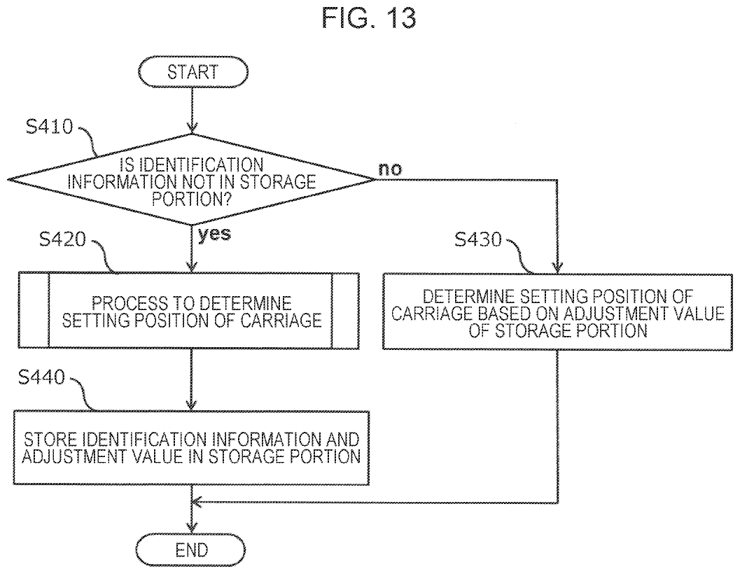

Next, a flow, which is represented by a flowchart of FIG. 13, when the colorimeter 100 to be used is changed will be described. As described above, the color measurement apparatus 1 of the present example is configured to attach and detach the colorimeter 100 to and from the carriage, and a plurality of types of the colorimeters 100 can be used. Each of the colorimeters 100 that can be used in the color measurement apparatus 1 of the present example has identification information. The storage portion 52a of the color measurement apparatus 1 of the present example can store identification information corresponding to each of the colorimeters 100.

When the new colorimeter 100 is attached to the carriage 30 and the flow of the flowchart of FIG. 13 is started, first, in a step S410, the main substrate 52 determines whether or not the identification information of the newly attached colorimeter 100 is stored in the storage portion 52a. When it is determined that the identification information of the newly attached colorimeter 100 is not stored in the storage portion 52a, the process proceeds to a step S420, and when it is determined that the identification information of the newly attached colorimeter 100 is stored in the storage portion 52a, the process proceeds to a step S430. Here, the step S420 is the control method itself represented by the flowchart of FIG. 10.

When the process proceeds to a step S430, since the adjustment value of the newly attached colorimeter 100 is already stored in the storage portion 52a, the setting position of the carriage 30 in the height direction is determined based on the adjustment value. On the other hand, when the process proceeds to the step S420, the setting position of the carriage 30 in the height direction is determined based on the adjustment value of the step S160 of the flowchart of FIG. 10 obtained by executing the step S420. After the step S420 is ended, the identification information and the adjustment value of the new colorimeter 100 are stored in the storage portion 52a. Then, the flow of the flowchart of FIG. 13 is ended in accordance with the end of a step S440 or the end of the step S430.

When the flow of the flowchart of FIG. 13 is described in other words, the identification information of the newly attached colorimeter 100 is acquired in the step S410. That is, the step S410 can be expressed as an acquisition step of acquiring first identification information in the identification information of a first colorimeter supported by the carriage 30 among the colorimeters 100. In addition, the step S410 can also be expressed as a determination step of determining whether or not the first identification information matches the identification information stored in the storage portion 52a. Then, as described above, when it is determined in the determination step that the first identification information does not match the identification information stored in the storage portion 52a, a storage step that stores the first identification information acquired in the acquisition step in the storage portion 52a is performed in the step S440, and the calculation step of the step S160 included in the step S420 is performed.

By executing such a control method, it can be determined whether or not to perform the calculation step for each of the colorimeters 100 to be newly used. Therefore, although the colorimeter 100 that is not previously used is attached, the height of the colorimeter 100 with respect to the color chart 10 can be suppressed from deviating from a desired height.

In the flow of the flowchart of FIG. 13, when it is determined in the step S410 to proceed to the step S430, in other words, when it is determined in the determination step that the first identification information matches the identification information stored in the storage portion 52a, the storage step of the step S440 and the calculation step of the step S160 included in the step S420 are not performed. By using such a control method, when the colorimeter 100 that is previously used is attached, the flow of determining the setting position of the carriage 30 illustrated in FIG. 10 can be omitted. Accordingly, the time required for the flow of determining the setting position of the carriage 30 can be shortened.

However, the present disclosure is not limited to this flow. Although it is determined in the step S410 that the identification information of the colorimeter 100 attached to the carriage 30 matches the identification information stored in the storage portion 52a, the process may proceed to the step S420, and the calculation step of the step S160 may be performed. This is because, for example, after a lapse of a predetermined time or after the color measurement apparatus 1 is transported, or the like, there is a concern that the setting position of the carriage 30 in a preferable height direction deviates.

The present disclosure is not limited to the above-described examples, and can be realized in various configurations without departing from the gist of the present disclosure. For example, the color measurement apparatus 1 of the present example is configured to measure the color of the color measurement target in a state of being in contact with the color measurement target, but may be applied to a configuration in which color measurement is performed on the color measurement target in a state of not being in contact with the color measurement target. In addition, for example, technical features in the embodiments corresponding to technical features in each form described in a column of the outline of the disclosure can be appropriately replaced or combined to partially or entirely solve the above-described problems, or to partially or entirely achieve the above-described advantageous effects. In addition, unless the technical features are described as essential in the present specification, deletion is possible as appropriate.

What is claimed is:

1. A control method of a color measurement apparatus including a support base that supports a color measurement target, a colorimeter that has a color measurement portion that measures a color of the color measurement target in a state of being in contact with the color measurement target, a carriage that supports the colorimeter, and a scanning mechanism portion that causes the carriage to perform scanning on the support base, the control method comprising:
a color measurement step of performing color measurement by the color measurement portion, by moving the carriage from the color measurement target in a height direction, at a plurality of positions having different gaps between the carriage and the color measurement target in the height direction; and
a calculation step of calculating an adjustment value for determining a setting position of the carriage in the height direction based on a color measurement result in the color measurement step.

2. The control method according to claim 1, wherein
in the calculation step, a height of the carriage from the color measurement target, when a color measurement value that is color-measured by the colorimeter in the color measurement step exceeds a predetermined threshold value, is obtained as a comparative value, and the adjustment value is calculated based on a difference between the comparative value and a reference value.

3. The control method according to claim 1, wherein
the color measurement step is performed in a state in which the color measurement portion is positioned at a center position of the color measurement target when viewed from the height direction.

4. The control method according to claim 1, wherein
the color measurement step is performed a plurality of times at a predetermined position of the color measurement target, and
in the calculation step, the adjustment value is calculated based on an average value of color measurement results in the color measurement step performed a plurality of times.

5. The control method according to claim 1, wherein
the color measurement step is performed at at least two or more positions of the color measurement target, and
in the calculation step, the adjustment value is calculated based on an average value of color measurement results in the color measurement step performed at two or more positions.

6. The control method according to claim 1, further comprising:
with the color measurement apparatus configured to use a plurality of types of the colorimeters, all of which have identification information, and including a storage portion configured to store the identification information,
an acquisition step of acquiring first identification information in the identification information of a first colorimeter supported by the carriage among the colorimeters; and
a determination step of determining whether or not the first identification information matches the identification information stored in the storage portion, wherein when it is determined in the determination step that the first identification information does not match the identification information stored in the storage portion, a storage step of storing the first identification information acquired in the acquisition step in the storage portion is performed, and the calculation step is performed.

7. The control method according to claim 6, wherein
when it is determined in the determination step that the first identification information matches the identification information stored in the storage portion, the storage step and the calculation step are not performed.

8. The control method according to claim 1, wherein
the setting position of the carriage is a position of the carriage in the height direction when color measurement is performed on the color measurement target.

9. The control method according to claim 1, wherein
the color measurement apparatus is configured to perform color measurement by the colorimeter by repeatedly causing the carriage to perform scanning with respect to a plurality of patches provided on the color measurement target, and
the setting position of the carriage is a position of the carriage in the height direction when the colorimeter is moved in scanning of the carriage from a first color measurement position to a second color measurement position corresponding to positions of the plurality of patches.

10. A color measurement apparatus comprising:
a support base that supports a color measurement target;
a colorimeter that includes a color measurement portion that measures a color of the color measurement target in a state of being in contact with the color measurement target;
a carriage that supports the colorimeter;
a scanning mechanism portion that causes the carriage to perform scanning on the support base; and
a control portion that controls the colorimeter, the carriage, and the scanning mechanism portion, wherein
the control portion
performs color measurement by the color measurement portion at a plurality of positions having different gaps between the carriage and the color measurement target in a height direction by moving the carriage from the color measurement target in the height direction, and
calculates an adjustment value for determining a setting position of the carriage in the height direction, based on a color measurement result of the color measurement portion.
